(19) United States
(12) Patent Application Publication
(10) Pub. No.: US 2012/0168123 A1
(43) Pub. Date: Jul. 5, 2012

(54) OVERHEAD-MOUNTED HEATSINK

(76) Inventors: Stephen Belgin, Soquel, CA (US); David North, Santa Clara, CA (US)

(21) Appl. No.: 12/984,431

(22) Filed: Jan. 4, 2011

(51) Int. Cl. F28F 9/00; F28D 15/02; B23P 19/04; F28F 7/00

(52) U.S. Cl. 165/80.2; 165/185; 165/104.21; 29/428

(57) ABSTRACT

An apparatus includes a supporting member, a cooling stage and a translating member. The cooling stage has a surface for contacting an electronic device. The cooling stage is translatably coupled to the supporting member. The translating member is coupled to the supporting member and attached to the cooling stage. The translating member is operable to translate the cooling stage relative to the supporting member to urge the cooling stage surface against the electronic device.

### TECHNICAL FIELD

This application is directed, in general, to a heatsink.

### BACKGROUND

Some modern electronic devices are capable of dissipating a large amount of power during operation. For example, some integrated devices, such as microprocessors, may generate as much as 50-150 watts. In general this heat must be conducted from the device to prevent an excessive temperature rise that may hinder proper operation or reduce the lifetime of the device.

### SUMMARY

One aspect provides an apparatus. The apparatus includes a supporting member, a cooling stage and a translating member. The cooling stage has a surface for contacting an electronic device. The cooling stage is translatably coupled to the supporting member. The translating member is coupled to the supporting member and attached to the cooling stage. The translating member is operable to translate the cooling stage relative to the supporting member to urge the cooling stage surface against the electronic device.

Another aspect provides a method. In a first step of the method a supporting member is provided. A translatable member is coupled to the supporting member. A cooling stage is attached to the translatable member. The cooling stage has a surface for contacting an electronic device. The cooling stage is operable via the translatable member to translate the cooling stage relative to the supporting member to urge the cooling stage surface against the electronic device

### BRIEF DESCRIPTION

Reference is now made to the following descriptions taken in conjunction with the accompanying drawings, in which:

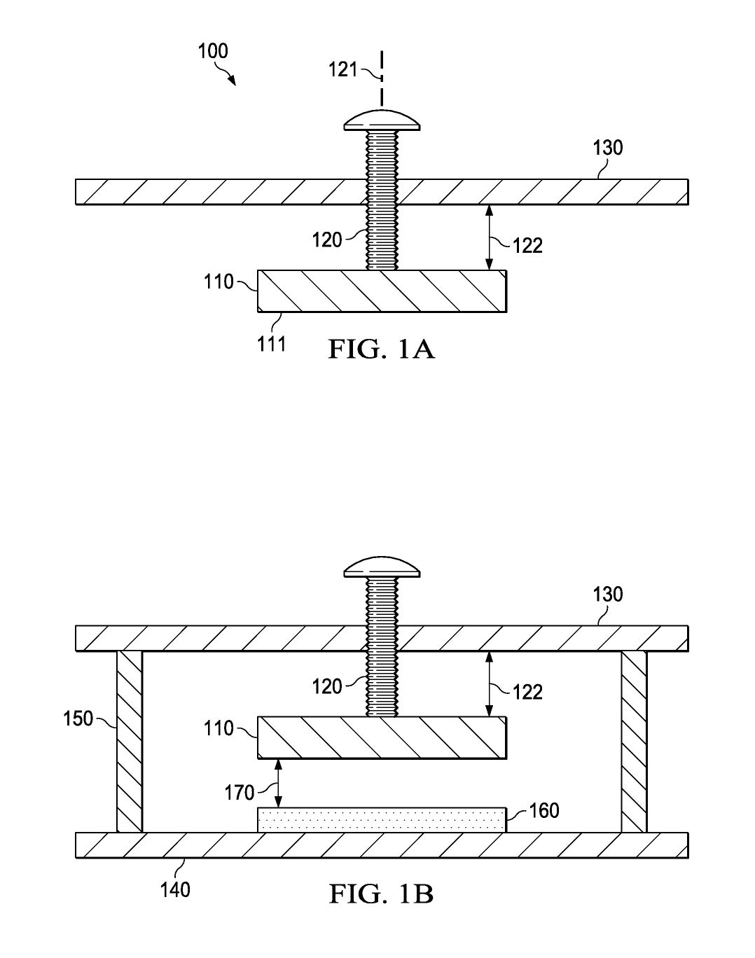

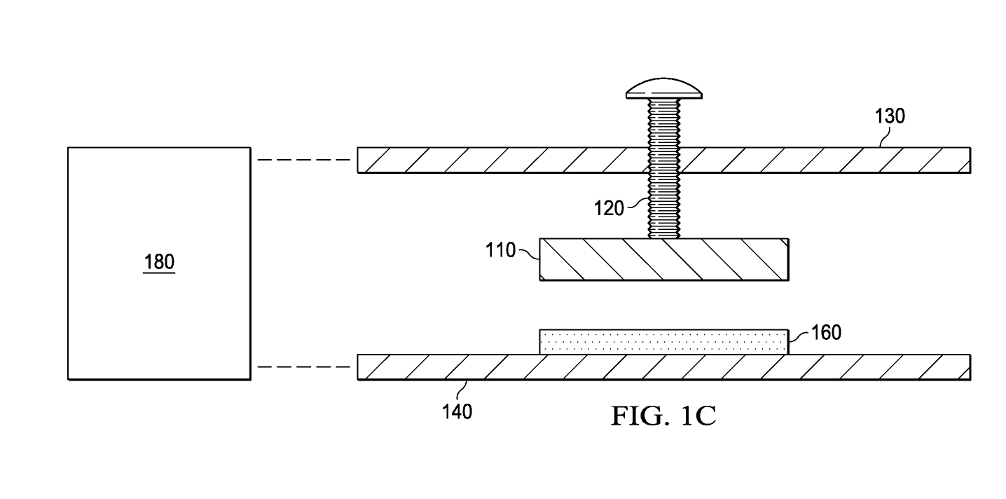

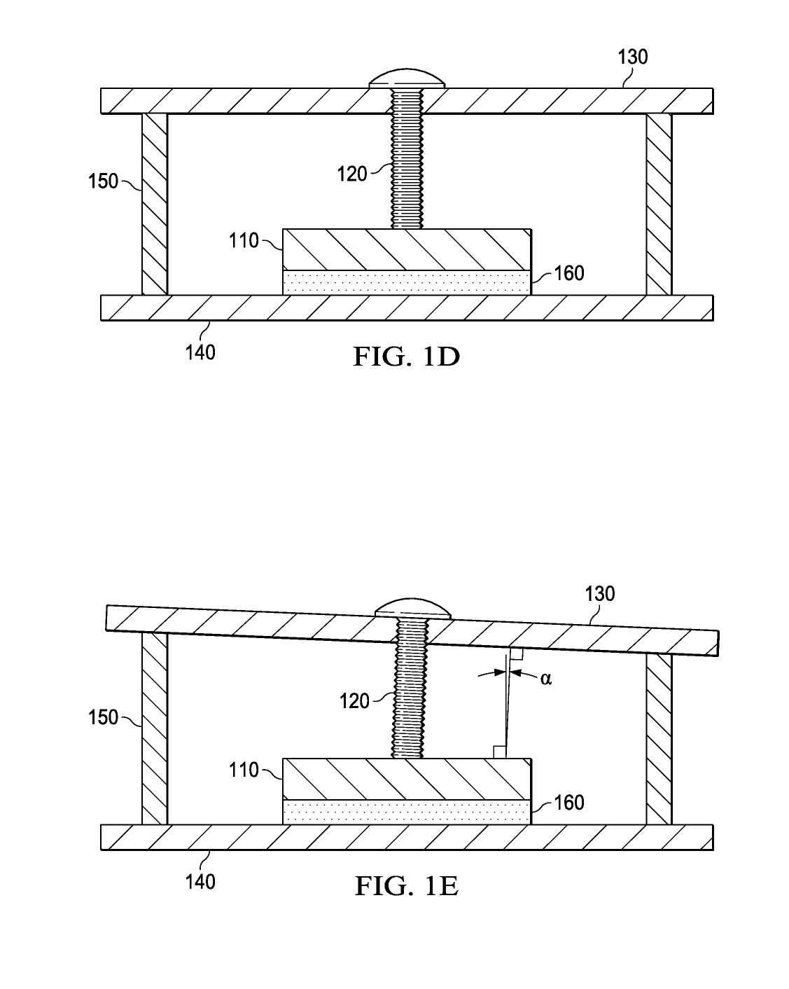

FIGS. 1A-1E illustrate embodiments of an apparatus of the disclosure including a supporting member, a translating member and a cooling stage that has a surface for contacting an electronic device;

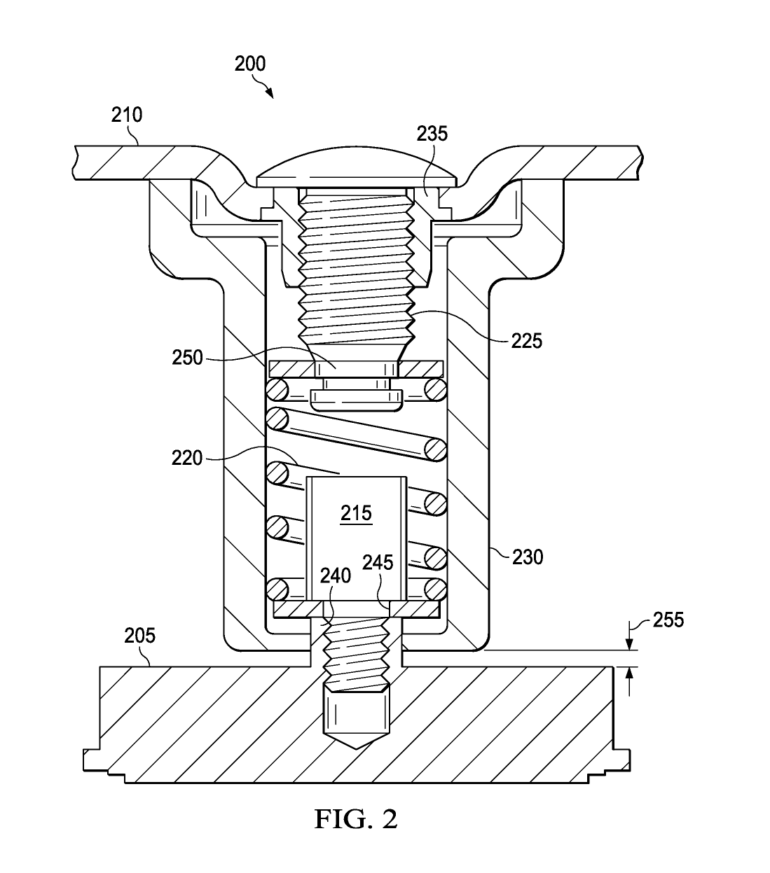

FIG. 2 presents a sectional view of an embodiment of a translating member that may be used in the apparatus of FIG. 1;

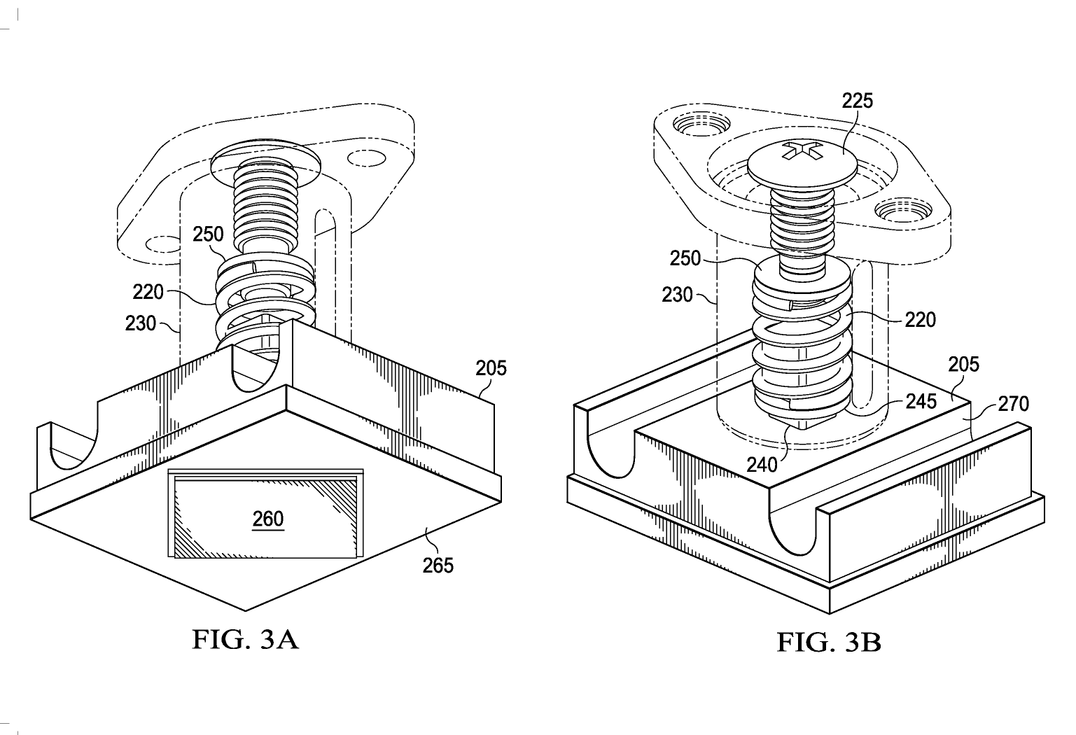

FIGS. 3A and 3B present additional views of the translating member of FIG. 2;

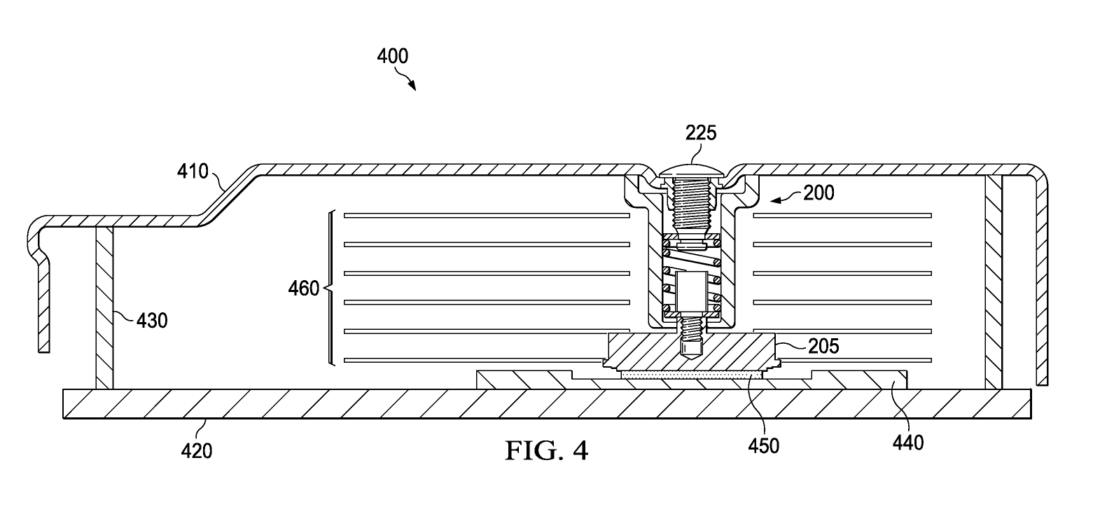

FIG. 4 illustrates an apparatus that includes a translating member located between a cooling stage and a supporting member, wherein the supporting member is an enclosure over a circuit board;

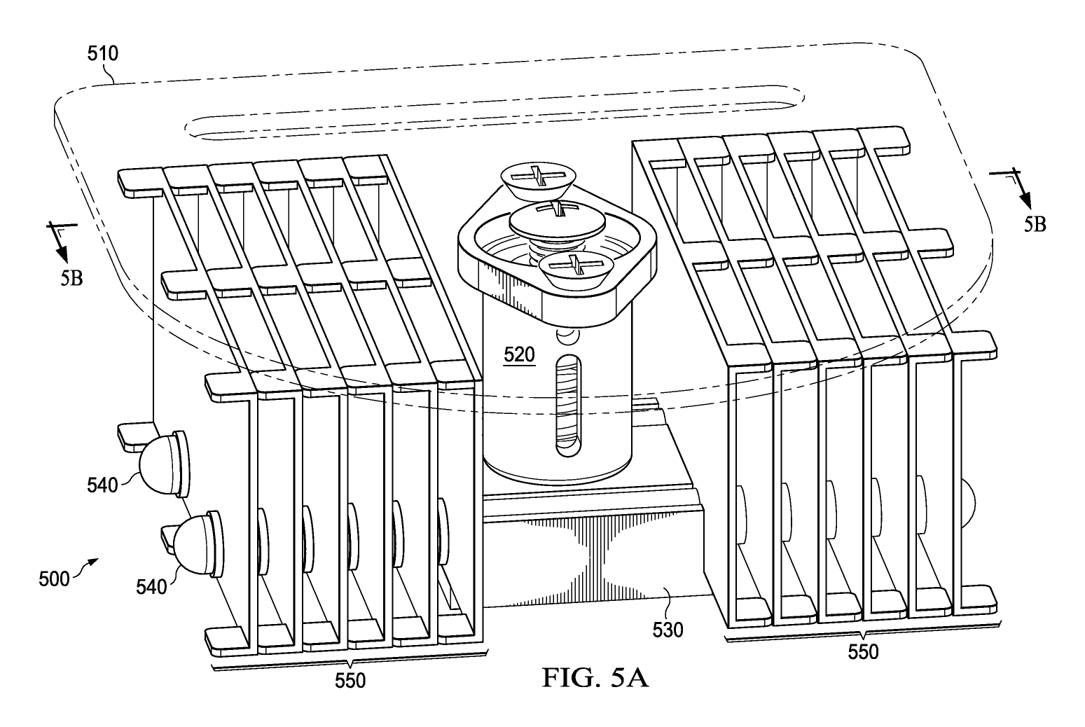

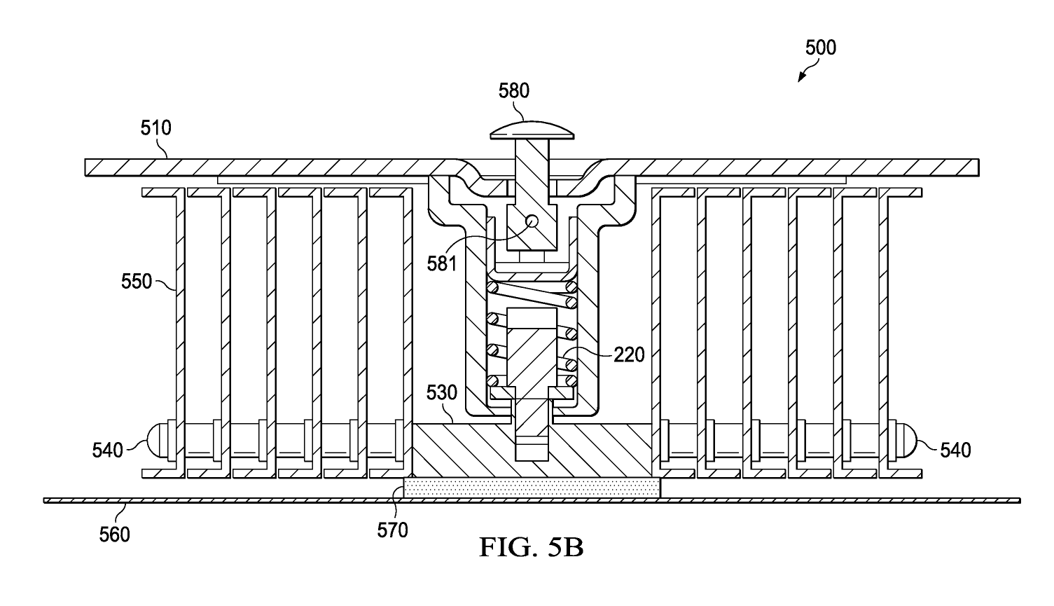

FIGS. 5A and 5B illustrate views of an alternate embodiment of an apparatus of the disclosure; and

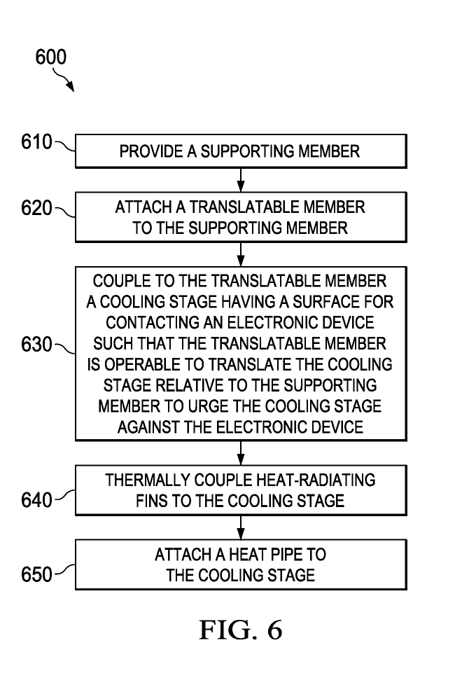

FIG. 6 presents an embodiment of a method of the disclosure, e.g. forming the apparatus of FIGS. 1A-1E, 4 or 5A.

### DETAILED DESCRIPTION

Some prior art heatsink assemblies include a cooling stage thermally and mechanically coupled to heat-radiating fins. The cooling stage may be placed in contact with an electronic device to be cooled. Heat from the device is conducted by the cooling stage to the heat-radiating fins and dissipated to the surrounding air. Such prior art heatsink assemblies typically include mounting hardware such as threaded inserts to join the assembly to a circuit board that includes the electronic device to be cooled.

The prior art heatsink is typically mounted to the circuit board using fasteners such as screws that pass through holes in the circuit board. Signal and power traces on the circuit board must be routed around these holes. As electronic systems become more complex it is sometimes desirable or necessary to route a large number of circuit traces near the electronic device. Thus the prior art heat sink is not well suited to such high-density circuit board layouts due to the space requirements of mounting the heatsink to the circuit board.

Another inadequacy of prior art heatsinks concerns damage to the electronic device being cooled. In some cases the electronic device is a semiconductor device in a lidless package. Typically such a device is packaged in a flip-chip configuration so that the underside of the semiconductor substrate upon which the device is formed is accessible. The cooling stage is placed in contact with the substrate to provide the desired cooling of the device.

The substrate is typically thinned in the manufacturing process to a final thickness of about 250 μm, and is thus fragile. If the cooling stage contacts the substrate with excessive force, the substrate may fracture. Such may occur, e.g., if the surface of the cooling stage is not substantially coplanar with the surface of the substrate when the cooling stage contacts the substrate.

The prior art heatsink assemblies must therefore be installed with a high degree of precision to limit the risk of substrate damage. Such precision may increase the installation time, and may not reduce the risk of damage below a desired limit.

The inventors have recognized that the aforementioned limitations of the prior art may be eliminated or substantially ameliorated by attaching the heatsink assembly, or a cooling stage thereof, to a supporting member such as an enclosure panel that is located over the electronic device. The enclosure panel may be, e.g. a cover that is attached to a circuit board that includes the electronic device, or attached to a support to which the circuit board and the cover are both attached. The heatsink assembly includes a translating member located between the cooling stage and the supporting member. The supporting member may include a compression assembly that may hold the cooling stage at a distance from the electronic device to prevent contact between the electronic device and the cooling stage while the enclosure panel and attached heatsink assembly are fastened over the electronic device. After the enclosure panel is installed, and its position relative to the electronic device is fixed, the compression assembly may be adjusted to urge the cooling stage against the electronic device, thus thermally coupling the electronic device to the cooling stage. Heat from the electronic device may then be transferred to the ambient with the aid of cooling fins, heat pipes, vapor chambers, etc.

Turning first to FIG. 1A, illustrated is an embodiment of an apparatus 100 of the disclosure. FIG. 1A includes a cooling stage 110. The cooling stage 110 includes a surface 111. The cooling stage 110 optionally is thermally coupled to heat-dissipating fins and/or a heat pipe and/or a vapor chamber to aid the transport of heat from the cooling stage 110 to the surrounding ambient.

The cooling stage 110 is attached to a translating member 120, e.g. a screw shaft. In some embodiments the cooling stage 110 and the translating member 120 are rotatably attached, such as by employing a ball joint. In such embodiments the translating member 120 may turn about an axis 121 while the cooling stage 110 remains stationary with respect to the axis 121. The translating member 120 is translatably coupled to a supporting member 130 via the translating member 120. By translatably coupled, it is meant that the translating member 120 may move vertically with respect to the supporting member 130 as FIG. 1A is presented, thereby changing a distance 122 between the supporting member 130 and the cooling stage 110. The supporting member 130 and the cooling stage 110 are therefore translatably coupled by the translating member 120 so that the cooling stage 110 may be translated vertically with respect to the supporting member 130 by operation of the translating member 120.

FIG. 1B illustrates the apparatus 100 rigidly attached to a substrate 140, such as a circuit board. The substrate 140 includes an electronic device 160. Herein rigidly attached means that the substrate 140 and the supporting member 130 are held at a distance from each other with sufficient stiffness that the surface 111 may be urged against the electronic device 160 with sufficient force to maintain a low thermal resistance therebetween. Herein, urge means to compressively load the surface 111 against the electronic device 160. Low thermal resistance means thermal resistance sufficiently low that heat may be conducted from the cooling electronic device 160 to lower the operating temperature thereof.

The translating member 120 may be configured to maintain a non-zero distance 170 between the cooling stage 110 and the electronic device 160. In this way, sufficient clearance may be maintained between the cooling stage 110 and the electronic device 160 when the supporting member 130 is joined to the substrate 140 to ensure that cooling stage 110 does not contact the electronic device 160.

The supporting member 130 may in some embodiments be attached directly to the substrate 140 via standoffs 150 as illustrated in FIG. 1B. FIG. 1C is representative of other embodiments in which the supporting member 130 and the substrate 140 may both be indirectly attached via an external structure 180. The external structure may be, e.g. a frame or enclosure element neighboring the substrate 140. In cases of indirect attachment the external structure 180 and any intermediate attachment members are sufficiently stiff that the distance between the supporting member 130 and the substrate 140 is rigidly fixed such that the surface 111 may be urged against the electronic device 160.

Referring to FIG. 1D, the cooling stage 110 may be translated in the direction of the electronic device 160 and placed in thermal communication therewith. Thermal communication means that a low-resistance thermal path is formed between the electronic device 160 and the cooling stage 110. The thermal communication may be augmented by a thermally conductive pad or thermally conductive grease. In such cases the surface 111 is considered to be in contact with the electronic device 160 even though a thermally conductive pad or thermal grease is located therebetween. The translating member 120 may be operated to urge the cooling stage 110 against the electronic device 160, e.g. to impose a compressive force therebetween.

Referring the FIG. 1E, the mechanical coupling between the translating member 120 and the cooling stage 110 may allow for limited rotation of the cooling stage 110 relative to the electronic device 160, such as by a ball joint. For example the standoffs 150 may not be precisely the same height and/or the surface of the supporting member 130 may not be coplanar with the electronic device 160. The limited rotation of the cooling stage 110 allows the apparatus 100 to accommodate such non-coplanarity. In FIG. 1E an angle α describes an angle of non-coplanarity of the supporting member 130 and the surface 111 of the cooling stage 110. In some embodiments the apparatus 100 is configured to accommodate an angle of non-coplanarity of at least about 3°.

FIG. 2 illustrates an apparatus 200 as an embodiment of the disclosure. The apparatus 200 includes a cooling stage 205 and a supporting member 210. A translating member 215, e.g. a threaded plug, couples the cooling stage 205 to the supporting member 210 via a spring 220 and a screw 225. A housing 230 contains the translating member 215, spring 220 and screw 225. The screw 225 engages a threaded hole 235 in the housing 230. The housing 230 may be attached to the supporting member 210 by, e.g. fasteners (e.g. screws), welding, brazing, soldering or adhesive.

The housing 230 includes an opening through which an annular portion 240 of the cooling stage 205 passes. The annular portion 240 supports the spring 220 via a ridge 245 such as a washer. The clearance between the housing 230 and the annular portion 240 may be, e.g. about 750 μm (˜30 mil) to allow the cooling stage 205 to rotate relative to the supporting member 210, such as to accommodate non-coplanarity of the supporting member 210 and the electronic device to be cooled.

The spring 220 is compressed between a washer 250 attached to the screw 225 and the ridge 245. The ridge 245 and the washer 250 may be attached to the spring 220, e.g. by a tack weld or adhesive. Vertical movement of the washer 250 is constrained by the screw 225. Motion of the ridge 245 is limited by the housing 230, but may move in the direction of the supporting member 210 as the spring 220 is further compressed or when the screw 225 is withdrawn from the threaded hole 235. The annular portion 240 is formed such that a gap 255 remains between the housing 230 and the cooling stage 205 when the ridge 245 rests against the annular portion 240. The gap 255 is not limited to any particular value, but in an illustrative embodiment is about 1 mm.

In some embodiments the washer 250 is captured by the screw 225 such that the washer may rotate relative to the screw 225. In such embodiments the washer 250, spring 220, ridge 245, translating member 215 and cooling stage 205 may rotate as a unit relative to the screw 225. Thus the cooling stage 205 is rotatably attached to the screw 225 in such embodiments.

FIGS. 3A and 3B illustrate a portion of the apparatus 200 from two additional perspectives. A contact surface 260 on the underside of the cooling stage 205 may stand off from a remaining surface 265 so that the contact surface 260 makes contact with an electronic device to be cooled while the remaining surface 265 does not. The contact surface 260 may have a similar shape and size (e.g. “footprint”) as the electronic device being cooled. For example, the side lengths of the contact surface 260 may be about the same as the side lengths of a silicon die on which the electronic device is formed. The cooling stage 205 also includes an optional channel 270 in which a heat pipe may be placed to conduct heat from the cooling stage 205.

When the screw 225 is withdrawn sufficiently from the threaded hole 235 the spring 220 may be placed in tension, and the cooling stage 205 may be pulled up until it rests against the housing 230. The apparatus 200, and more specifically the contact surface 260, may then be placed proximate, but not touching, an electronic device to be cooled. Any desired mechanical adjustments that affect the relative position of the contact surface 260 and the electronic device may be made without contact therebetween. When the position of the contact surface 260 is rigidly fixed relative to the electronic device, then the screw 225 may be inserted further into the threaded hole 235, causing the cooling stage 205 to translate away from the supporting member 210 until the contact surface 260 contacts the electronic device. Further insertion of the screw 225 may compress the spring 220, thereby urging the contact surface 260 against the electronic device.

FIG. 4 illustrates an apparatus 400 that includes at least one instance of the apparatus 200. An enclosure 410 acts as the supporting member of the apparatus 200. The enclosure is attached to a circuit board 420 by standoffs 430. The circuit board 420 includes an electronic device package 440, illustrated without limitation as a lidless package. Within the electronic device package 440 is an electronic device 450, such as an inverted flip-chip semiconductor die. The cooling stage 205 is in thermal contact with the electronic device 450. Heat from the electronic device 450 may be conducted by the cooling stage 205 to horizontally-oriented radiating fins 460 with the aid of supporting structures, heat pipes, vapor chambers and the like.

In the illustrated embodiment the enclosure 410 at least partly encloses a space that includes the electronic device 450, the apparatus 200 and the radiating fins 460. A fan (not shown) may cause air to flow within the enclosed space, thereby transferring heat from the radiating fins 460 to the air.

The apparatus 400 may be initially configured such that the cooling stage 205 is translated toward the enclosure 410 to the maximum extent possible. The enclosure 410 may then be attached to the circuit board 420 without the cooling stage 205 contacting the electronic device 450, thereby reducing the chance of damage to the electronic device 450 during assembly. After assembly, the screw 225 may be partially or fully inserted to cause the cooling stage 205 to translate away from the enclosure 410 and toward the electronic device 450. The contact surface 260 is expected to be substantially coplanar with the surface of the electronic device 450, so pressure therebetween is expected to be about evenly distributed over the electronic device 450. The spring constant of the spring 220 may be selected to result in a compressive force between the cooling stage 205 and the electronic device 450 that results in low thermal resistance therebetween without placing excessive force on the electronic device 450.

FIGS. 5A and 5B respectively illustrate a perspective view and a section of an apparatus 500. Embodiments of the apparatus 500 include optional features that may be practiced in various embodiments of the disclosure. The apparatus 500 includes a supporting member 510 (e.g. a metal panel) to which a translating member 520 is attached. The translating member 520 includes the spring 220 that operates as previously described. The translating member 520 includes a cooling stage 530. Heat pipes 540 are thermally and mechanically connected to the cooling stage 530. The heat pipes 540 are mechanically and thermally connected to vertically-oriented radiating fins 550.

Those skilled in the pertinent art will appreciate that a heat pipe is a closed volume that includes a working fluid that that may transport heat from one location within the heat pipe to another location within the heat pipe via a vaporization-condensation cycle. Heat pipes are often cylindrical but need not be. Movement of the condensed phase of the working fluid may include transport within a wick placed along the inner surface of the heat pipe. Those skilled in the pertinent art will also appreciate that a vapor chamber is an analog of the heat pipe that uses first and second surfaces that may be opposing. A heat source may be placed in thermal contact with the first surface, and an internal vaporization-condensation cycle may transport heat from that location to another location on the first surface, or to the second surface.

The supporting member 510 and a substrate 560 such as a circuit board are rigidly attached either directly, such as by standoffs, or indirectly by way of an external mechanical assembly as previously described. The cooling stage 530 is urged against an electronic device 570, also as previously described.

In the illustrated embodiment a captive quarter-turn fastener 580 is used to compress the spring 220 after the cooling stage 530 is located over the electronic device 570. The fastener 580 and the spring 220 are configured such that when the fastener 580 is in an initial position the cooling stage 530 is retracted, e.g. translated toward the supporting member 510. A non-zero distance may thereby be maintained between the cooling stage 530 and the electronic device 570 during assembly of the apparatus 500. After rigidly attaching the supporting member 510 to the substrate 560 the fastener 580 may be rotated about 90°. The fastener 580 includes a pin 581 that engages a cam (not shown) to compress the spring 220 and thereby translate the cooling stage 530 toward the electronic device 570. The cooling stage 530 may thereby be urged against the electronic device 570 as previously described. The cam may include a recess into which the pin 581 may be retained in the compressed or uncompressed positions to ensure stability of the position of the cooling stage 530.

Turning now to FIG. 6, an embodiment of a method generally designated 600 is presented. The method 600 may be used, e.g. to manufacture the apparatus 100. The steps of the method 600 may be carried out in an order other than the order presented.

The method begins with a step 610, in which a supporting member is provided, such as one of the supporting members 130, 210, 510 or the enclosure 410. Herein and in the claims, “provided” means that the supporting member may be manufactured by the individual or business entity performing the disclosed methods, or obtained thereby from a source other than the individual or entity, including another individual or business entity.

In a step 620 a translatable member is attached to the supporting member. The translatable member is exemplified by the translating members 120, 215, 520.

In a step 630 a cooling stage is coupled to the translatable member. The cooling stage is exemplified by the cooling stages 110, 205, 530. The cooling stage has a surface such as the contact surface 260 for contacting an electronic device. The translatable member is thereby operable to translate the cooling stage relative to the supporting member to urge the cooling stage against the electronic device.

In an optional step 640 heat-radiating fins such as the radiating fins 460 are thermally coupled to the cooling stage. In an optional step 650 a heat pipe such as the heat pipe 540 is attached to the cooling stage.

Those skilled in the art to which this application relates will appreciate that other and further additions, deletions, substitutions and modifications may be made to the described embodiments.

What is claimed is:

1. An apparatus, comprising:
a supporting member;
a cooling stage translatably coupled to said supporting member, said cooling stage having a surface for contacting an electronic device;
a translating member coupled to said supporting member and attached to said cooling stage, said translating member being operable to translate said cooling stage relative to said supporting member to urge said cooling stage surface against said electronic device.

2. The apparatus as recited in claim 1, wherein said supporting member is a portion of an enclosure configured to at least partially enclose a space between said supporting member and said electronic device.

3. The apparatus as recited in claim 1, wherein said cooling stage is rotatably attached to said translating member.

4. The apparatus as recited in claim 1, wherein said cooling stage and said translating member are coupled via a spring configured to urge said cooling stage surface against said electronic device.

5. The apparatus as recited in claim 1, wherein said cooling stage includes an annular portion that supports said spring.

6. The apparatus as recited in claim 1, wherein said translating member includes a threaded screw portion that engages said supporting member and is rotatably attached to said cooling stage.

7. The apparatus as recited in claim 1, wherein said cooling stage is configured to allow said cooling stage surface to tilt relative to said supporting member by at least about 3°.

8. The apparatus as recited in claim 1, further comprising an electronic circuit board that includes said electronic device, wherein said supporting member is rigidly attached to said circuit board.

9. The apparatus as recited in claim 1, further comprising heat-radiating fins thermally coupled to said cooling stage.

10. The apparatus as recited in claim 1, further comprising a heat pipe attached to said cooling stage.

11. A method, comprising:
providing a supporting member;
attaching a translatable member to said supporting member; and
coupling to said translatable member a cooling stage having a surface for contacting an electronic device such that said translatable member is operable to translate said cooling stage relative to said supporting member to urge said cooling stage surface against said electronic device.

12. The method as recited in claim 11, wherein said supporting member is a portion of an enclosure configured to at least partially enclose a space between said supporting member and said electronic device.

13. The method as recited in claim 11, wherein said cooling stage is rotatably coupled to said translating member.

14. The method as recited in claim 11, wherein said cooling stage and said translating member are coupled via a spring configured to urge said cooling stage surface against said electronic device.

15. The method as recited in claim 14, wherein said cooling stage includes an annular portion that supports said spring.

16. The method as recited in claim 11, wherein said translating member includes a threaded screw portion that is captured by said supporting member and rotatably coupled to said cooling stage.

17. The method as recited in claim 11, wherein said cooling stage is configured to allow said cooling stage surface to tilt relative to said supporting member by at least about 3°.

18. The method as recited in claim 11, wherein said electronic device is attached to an electronic circuit board, and said supporting member is rigidly attached to said circuit board.

19. The method as recited in claim 11, further comprising thermally coupling heat-radiating fins to said cooling stage.

20. The method as recited in claim 11, further comprising attaching a heat pipe to cooling stage.
